(19) United States
(12) Patent Application Publication
(10) Pub. No.: US 2007/0272303 A1
(43) Pub. Date: Nov. 29, 2007

(54) APPARATUS AND METHOD FOR CONTAINING AND COLLECTING CONCRETE WASH RESIDUE

(76) Inventor: Anthony Vizl, (US)

Correspondence Address: EDWIN TARVER, 16830 Ventura Blvd., SUITE 360, Encino, CA, 91436, US

(21) Appl. No.: 11/738,361

(22) Filed: Apr. 20, 2007

Related U.S. Application Data
(63) Continuation-in-part of application No. 11/440,981, filed on May 25, 2006.

(51) Int. Cl. B67D 5/00

(52) U.S. Cl. 137/313

(57) ABSTRACT

A concrete wash residue collection structure includes a catch basin in which the constituents of wet concrete dislodged by a stream of washing water directed at the working surfaces of concrete handling equipment is first collected is then mounted on a carrier vehicle to be transported along a path along which smaller wash residue collection trays are placed to be lifted and drained into the basin. Throughout this collection process the agitated liquid portion containing the reactive constituents of the concrete entrained therein are then passed into a collection enclosure through slotted filter housings that exclude the larger solid constituents of the concrete like sand and aggregate which further accumulate at the slots to form decanting weirs over which the liquid passes. The liquid collected in the enclosure may is continuously pumped out to be thereafter neutralized while the accumulated aggregate residue collected in the basin is disposed in a landfill.

### CROSS-REFERENCE TO RELATED APPLICATION

This continuation-in-part application claims the priority benefit of U.S. patent application Ser. No. 11/440,981, filed on May 25, 2006.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Reference to Related Applications

This application is a continuation-in-part of U.S. patent application Ser. No. 11/440,981 first filed on May 25, 2006, and the benefit of this earlier filing date is claimed for all matter common therewith.

2. Field of the Invention

The present invention relates to wash residue containment structures, and more particularly to containment and collection structures useful in collecting, confining and transporting concrete and stucco wash residues for disposal thereof.

3. Description of the Prior Art

Mixed concrete and wet cement are frequently utilized in the construction industry either to form various concrete strictures or to form both exterior and interior wall surfaces often referred to as stucco finish. These tasks are assisted by various tools and heavy machinery which at the end of its current use needs to be cleaned and prepared for its next use. These periodic washings are dictates by the very nature of concrete and its very hard structure once set up. Simply, the hardened form of the substance requires that all the working surfaces of the machinery and tools by which it is worked need to be washed before the substance sets up. In the course of a large construction project these repeated washings produce substantial quantities of highly caustic liquid residue that then needs to be safely contained to limit any harm to the environment.

It should be appreciated that the proper disposal of washing fluids is no longer just a matter of good taste or good practice but is currently a subject of profound public concern and regulatory attention. Current damage to our environment is palpable and great public attention is now focused on any processes that either affect the pH of our waters or otherwise contaminate native chemistry balances. Of course, these concerns express themselves in regulatory enactments and enforcement consequences of these regulatory schemes, like the Clean Water Act, have recently resulted in several notoriously large penalty assessments.

Moreover, this Act, generally expressed in Title 40, Code of Federal Regulations, Sections 101 through 607, is on a constant amendatory path to include even more restrictive language and more robust penalty provisions as the cumulative impact of human activity on the environment approaches critical levels. All sorts of processes and mechanisms for the amelioration of the environmental consequence to any activity are now an inherent part of all commercial endeavors, compounded by a layered architecture of the regulatory schemes and enforcement agencies of the several States and municipal organizations. In consequence, one simply does not release wash residues into the environment anymore, nor does one accumulate or store it in any manner where an inadvertent spillage or release could occur.

In the past various containment structures have been devised which in one manner or another seek to collect and confine contaminated wash residues, exemplified by the teachings of U.S. Pat. No. 5,547,312 to Schmitz, Jr.; U.S. Pat. No. 6,648,008 to Price; U.S. Pat. No. 5,099,872 to Tarvin et al.; U.S. Pat. No. 7,117,995 to Connard III; U.S. Pat. No. 6,866,047 to Marvin; and others Each of the foregoing teachings describe either a portable wash collection assembly or a deployable structure that sometimes includes an elastic or compliant containment membrane that is laid on the ground to provide an erectable peripheral barrier for confining the draining wash fluids while such are concurrently pumped out into a collection container for disposal. While suitable for the purposes intended, these prior art structures do not fare well under heavy loads like concrete residue. Moreover, the flexible peripheral structure either has to be folded down for ingress or egress, a time consuming task, or like in the '312 patent for example, a pair of robust ramps reeds to be positioned spanning over the periphery to allow the passage of the truck or other mobile structure that is to be washed in the containment basin, with the passage of heavy equipment over these temporarily positioned ramps consuming inordinate amounts of labor and equipment time. These labor intense aspects are particularly bothersome in large construction projects where great amounts of pre-mixed concrete are brought to the site in a sequenced train of transit mixer trucks, each truck and its associated pumping or delivery mechanism thereafter requiring a fairly thorough washing right at the site before returning to the concrete plant.

This continuing product of the wash process is currently accumulated in large containers in which the upper water strata of the wash residue contain the caustic liquid that, with time, then promote the further setting and hardening of the heavier residues layered on the container bottom. Of course, once fully set up these bottom layers are chemically inert and only the left-over liquid layer obtains any containment and disposal attention. The bottom pad in the container is then lifted and dumped as land fill.

It bears emphasis that the foregoing practice leaves the constituents of a highly diluted cement mix stationary, giving time for the reactive components of the concrete process to interact towards a harder, more difficult to handle, residue pad. Since the strength of a diluted cement mix is compromised any mechanism that separates the liquid and solid residue streams on a continuous basis will greatly simplify the eventual disposal task while also reducing congestion at the work site cluttered by stationary containers each full of caustic water on top of a well hardened bottom cake. A mechanism that effectively resolves these concerns is of a particular current interest in the heavy construction business and it is one such mechanism that is disclosed herein.

This same mechanism, moreover, once mounted on a rolling platform, may also be useful as a mobile collection facility into which the contents of smaller wash collection trays can be drained as the mobile facility is moved through the work site. In this manner a distributed set of smaller containers can service the cleaning needs of the various finishing processes such as those entailed in applying stucco finish onto the erected wall structures and the like. Of course, such a mobile facility may also include the above mentioned attribute for continuously separating the caustic liquid from the wash residue.

### SUMMARY OF THE INVENTION

Accordingly, it is the general purpose and object of the present invention to provide a mobile containment structure for collecting concrete wash residue in the course of its transport through a work site which in the course of this movement separates the wash liquid in from the accumulated solid debris.

Other objects of the invention are to provide a movable containment structure useful in collecting and containing concrete wash slurry collected at various places of a work site and decanting the liquid strata of the collected slurry for separated storage in accordance with the accumulation of solid debris.

Further objects of the invention are to provide a mobile containment structure provided with a lifting mechanism for raising collection trays distributed through a work site and draining the concrete wash slurry collected therein.

Yet additional objects of the invention are to provide a plurality of wash trays useful for collecting concrete wash slurry, each tray conformed for nested receipt in the others and each tray including variously aligned forklift blade receiving structures for the manipulation thereof.

Briefly, these and other objects are accomplished within the present invention by providing a generally rectangular containment structure defined by a bottom surface rolled in generally arcuate bends to form opposing, vertically aligned side walls each extending between transversely aligned front and rear end surfaces to form a storage cavity therebetween. Yet another transversely aligned intermediate wall extends across the cavity adjacent the front surface to separate the cavity into a front and rear portions, the front portion conformed as a generally rectangular chamber closed from the environment by a covering top surface. The open rear cavity portion is then useful to collect the wash residue that falls from concrete handling devices that are brought to the rear wall to be washed while extending thereover through a horizontally hinged upper gate panel pivoted from the upper edge of a lower gate panel extending across the rear surface to present a threshold height when the upper panel is opened that accommodates the lowest one of the various devices supported on ground and to allow the eventual disposal of the accumulated debris when the lower panel is released.

Those skilled in the art will appreciate that in the course of washing concrete tools and handling devices the liquid portion of the wash residue will entrain in the wash flow the unbound constituents of cement as various hydroxides and will thus be highly caustic while the solid part of the wash residue is effectively inert. The distinct nature of these two parts of the residue stream inherently entail wholly distinct handling and storage constraints, one part comprising sand and gravel with the other caustic liquid part presenting the primary environmental concerns. Since washing efficacy relates directly to the amount of water used and its stream energy there is an inherent dilution of the constituents of cement which degrades their bonding of the solid residue, thus greatly simplifying its removal from the collection cavity. Any commercially available bond release agent may be sprayed onto the receiving surfaces of the basin nonetheless, to minimize those instances where some residual cement paste may occasionally bond the solid residue to the basin walls.

For these reasons a liquid conveyance facility is provided within the present invention for draining off the liquid from the generated concrete wash slurry and conveying it to the front storage chamber from where it may be pumped into containers and thereafter neutralized. This conveyance is effected through a pair of laterally spaced and vertically aligned cylindrical housings that form a part of the separation wall, each housing spaced in the wall adjacent a corresponding one of its two lateral ends. That pat of the cylindrical surface of each housing that extends into the rear cavity forming the wash collection tray is provided with a narrow vertical slot extending substantially over its full length while the opposite cylinder surface is perforated by an opening of substantial dimension. A conformingly mated filter assembly is then insertable in each of the housing to limit transmission of particulates into the front storage chamber and concurrent therewith to insure an accumulation of the solid debris across the slot to effectively form a decanting weir.

It will be appreciated that this structural combination resolves all the currently competing aspects of proper cleaning of concrete handling equipment in an assembly that can be conveniently mounted on skids for movement along with the movement of the construction site. The same skid base may also include the necessary inclinations for proper draining alignment and also all such roller provisions as may be needed. Of course, the liquid storage chamber may further include connection fittings for the necessary pump-out and the solid debris portion may include all such fairing provisions that would assist in the removal of the debris. The continuous separation of the diluted cement bearing wash product stream thus removes with it the reagents of the hydration process, reducing the efficacy thereof within the remaining residue. This separation process, therefore, simplifies the disposal or the inert aggregate residue while at the same the confirming the hazardous constituents for neutralizing or other processing. The containment assembly may be rolled along an incline onto the bed of a truck to carry the separated solid part of the wash residue to a dump site while the remaining liquid part may continue to be pumped during this transport into a container also mounted on the truck. The separated and collected caustic liquid may then be periodically drained in a neutralizing facility where it is rendered safe to the environment once again.

This same mobile basin arrangement may also be utilized to periodically collect the wash residues from various finishing processes throughout the work site, such as the washing residues of the various mechanisms and tools used in stucco finishing and the like. Such labor intense finishing functions entail much smaller concrete handling devices and consequently much smaller wash trays are required, preferably distributed throughout the work site for proximity convenience. For further convenience each of the trays may be conformed as a generally square tapered structure of substantially equal dimensions to accommodate stacking into a nested storage stack when not in use. A set of fork lift pockets may be formed on the exteriors of the tray walls to allow for the lifting thereof by way of a forked lifting mechanism fixed to one lateral side of the truck bed or by the fork blades of a conventional forklift provided with a turning mechanism to pivot the tray over the basin for drainage. In this manner the same equipment is rendered useful to collect all the concrete wash residues produced at a work site.

### BRIEF DESCRIPTION OF THE DRAWINGS

FIG. 1 is a perspective illustration, separated by parts, of the inventive concrete wash containment and collection structure,

FIG. 2 is a further perspective illustration of the inventive concrete wash collection and containment structure illustrated in FIG. 1 in its assembled configuration;

FIG. 3 is a side view detail, in partial section, of one of several filter housings in accordance with the present invention;

FIG. 4 is a side view, in section, of the inventive concrete wash containment and collection structure taken along line 4-4 of FIG. 2;

FIG. 5 is a process flow diagram illustrating the operation of the inventive concrete wash containment and collection structure in its continuous mode of operation;

FIG. 6 is a perspective detail of the rear gate assembly in accordance with the present invention;

FIG. 7 is a side view of the inventive concrete wash containment and collection structure inclined for removal of the solid debris accumulated therein;

FIG. 8 is a further perspective illustration of the inventive wash collection and containment structure mounted on a truck bed for mobile use;

FIGS. 9a and 9b are each perspective illustrations of said tray respectively deployed for containing wash residue and in a nested storage arrangement; and

FIG. 10 is a further process diagram illustrating the inventive sequence of steps useful in disposing wash products generated in concrete finishing operations.

### DESCRIPTION OF THE PREFERRED EMBODIMENT

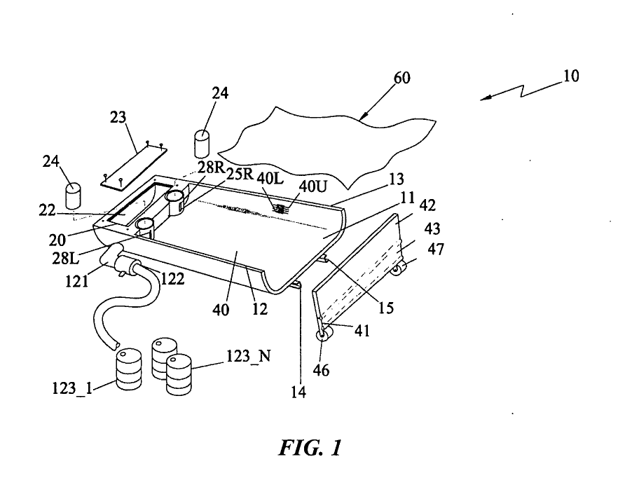

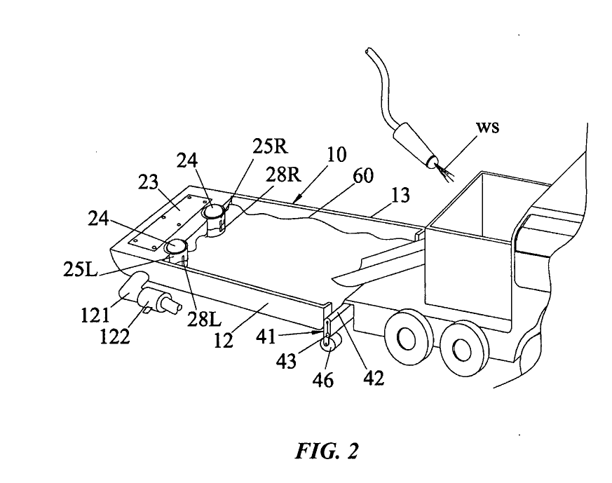

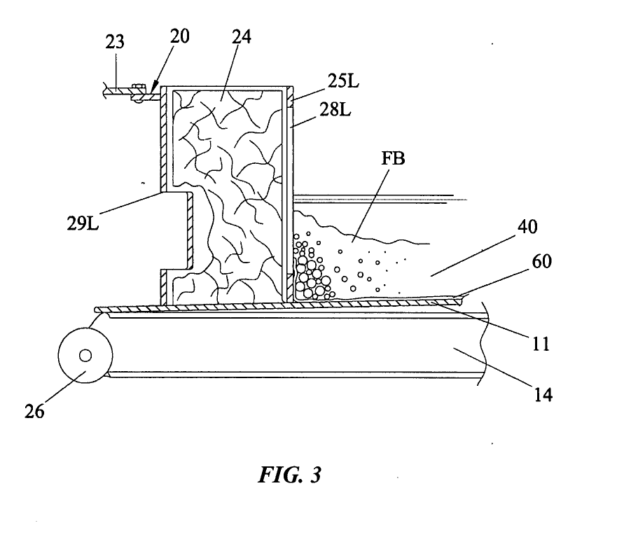

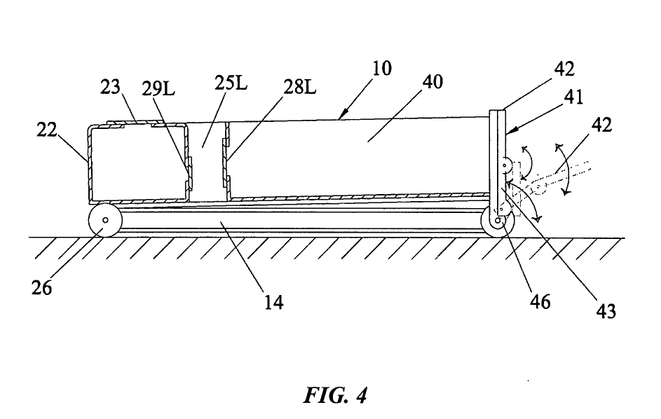

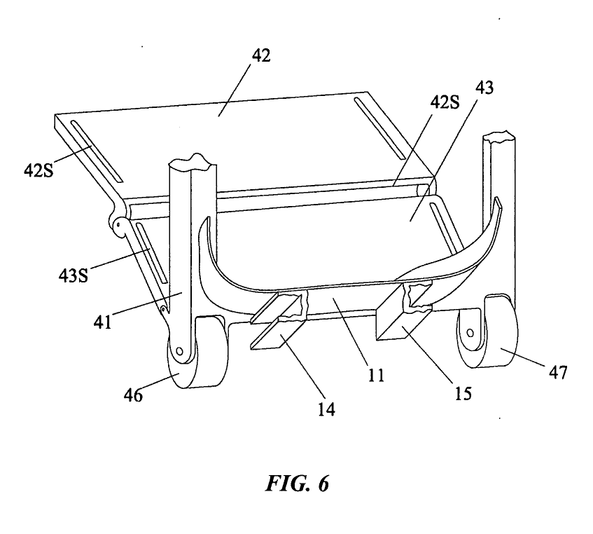

As shown in FIGS. 1-4 and 6, the inventive concrete wash containment and collection structure, generally designated by the numeral 10, is substantially configured as an elongate collection trough formed by rolling the lateral edges of a rectangular bottom plate 11 along axes that are partly spread from a parallel alignment to form side walls 12 and 13 separated by an increasing width from the narrower trough dimension at its forward end. A vertical transverse wall 21 extends across the trough next to its forward end dividing the cavity into a forward enclosure 20 closed at the forward trough edge by a vertical end panel 22 and covered from the environment by a top access plate 23 to form an impervious closed structure in which liquids may be stored. The larger remaining portion of the trough that extends beyond the separating wall 21 then forms an open rear basin 40 closed at the rear edge by rectangular panel assembly 41 provided with an upper and lower horizontal gate panels 42 and 43 hinged to each other and to the lower edge of assembly 41 so that when the upper panel 42 is opened, a threshold is set to the minimum height above ground for any structure that is extended thereover and when both the upper and lower panels are released full evacuation of basin 40 is then effected.

This structural combination may be supported on ground on a pair of C-channel sectioned skids 14 and 15 extending longitudinally beneath bottom panel 11 in a spaced alignment relative the bottom surface, with the channel spacing fixed by the lower edge projection 41L of panel assembly 41 at one end to a direct contact with the bottom panel 11 at the forward edge. In this manner a forwardly biased downward inclination of the bottom panel 11 extending between the lateral walls 12 and 13 is provided to direct the fluid flows towards wall 21. A set of outer rollers 46 and 47 at the lower corners of panel 41 then provides rolling convenience over ground while another set of support rollers 26 and 27 fitted adjacent the skid channels 14 and 15 at the forward end are useful in loading and unloading the structure onto tracks in a carrier vehicle CV. Once thus deployed either gate 42 is opened to allow the dispensing part DP of the washed concrete machinery CM to extend over the rear basin 40 for collecting the wash products therein that are emitted through the dispensing part DP when the machinery is washed.

Those skilled in the art will appreciate that the concrete setting process using portland cement entails a hydration reaction of the oxides of calcium, silicon and aluminum. As the hydration solids are formed the heat of their reaction, over time, drives off the excess local water that is not chemically bound as steam. This process, however, loses efficacy once an overabundant amount of water is introduced, as in the course of a wash, since the excess water flow rinses off the cement powder off the aggregate, diluting it to a point where the reaction is no longer sustainable. A thorough washing, therefore, invariably results in wholly loose aggregate along with large quantities of water carrying the highly diluted cement which when allowed to evaporate to higher concentrations within the aggregate may start binding it to itself and to the walls of the container. While the bonds that result in the course of evaporation are minimally effective their result is, nonetheless, bothersome as any prolonged retention of even the highly diluted cement reagents within the residue aggregate following washing will promote hydration. For this reason, and those imposed by statute focused on limiting inadvertent spillage, a flexible membrane 60 may be positioned in basin 40 to be recovered once the residue is disposed. Alternatively, a releasing agent such as the form release agent sold under the mark or style HUB SURE-STRIP FORM RELEASE 55GA by EDOCO, 22039 South Westward, Long Beach, Calif. 90810 may be sprayed onto the interior surfaces of the basin 40 prior to its use.

When used membrane 60 is laid in basin 40 leaving exposed the conveyance paths for a controlled draining of wash fluid that also carries away with it the diluted cement powders forming the paste for collection in enclosure 20, while at the same time separating and leaving behind the sand and washed aggregate in basin 40. To effect this the separation wall 21 includes a pair of vertically aligned tubular housings 25l and 25r each straddling the plane of the wall proximate the corresponding right or left side wall 12 or 13 within conforming wall surface gaps. Both the housings 25l and 25r are provided with a corresponding narrow vertical slot 28l and 28r formed in that portion of their walls that extends into the basin 40 while substantially larger openings 29l and 29r are formed in the opposing housing surfaces that extend into enclosure 20, thereby forming a liquid communication path thereacross. A set of conforming cylindrical filter assemblies 24 are then each receivable in the corresponding housings 25l and 25r to control and limit any transfer of the larger sized particulates of the aggregate. After insertion filters 24 may be periodically turned relative the slots to present a fresh surface to the flow. Preferably, the vertical slots 28l and 28r are each of a narrow transverse width dimension that is smaller than the dimension of the bulk of the aggregate. Consequently, the aggregate and sand will accumulates at each of the slots to form a filtering bed FB that further limits any aggregate transfer into enclosure 20.

Those skilled in the art will further appreciate that any concrete equipment washing is best effected by substantial and robust water streams. Simply, since the concrete transit and pumping equipment, in itself, provides a fairly integral enclosure having few exit openings robust washing stream WS is needed to reach all the interior surfaces thereof. As result the wash product flows that emerge from the washed mechanism are themselves quite agitated, thus providing the energy in basin 40 to further disturb the aggregate beds that have collected therein. In the course of this further agitation any of the cement paste that may remain in the bed is further dispersed and diluted, thereby limiting any potential of setting of the wash products therein. The resulting aggregate bed that accumulates at each entry slot will therefore remain in its loose form for convenient disposal out of the basin once it is full. The same deposit of the sand and aggregate filter bed FB at each slot 25l and 25r also serves a decanting purpose since the higher strata of the agitated basin content will inherently contain the lower density, or more diluted, cement paste flows. Accordingly, the inventive structural arrangement synergistically obtains benefit from the washing process itself to separate the diluted concrete paste from the aggregate, thereby simplifying the removal and disposal of the inert and massive part of the wash product while the caustic hydroxide parts of the hydration reaction are separately collected for neutralization and disposal. For these reasons the enclosure 20 is further provided with a pump-out port 121 which may be periodically connected to a powered pump 122 that transfers its caustic contents into drums 123-1 through 123-n to be thereafter neutralized and disposed.

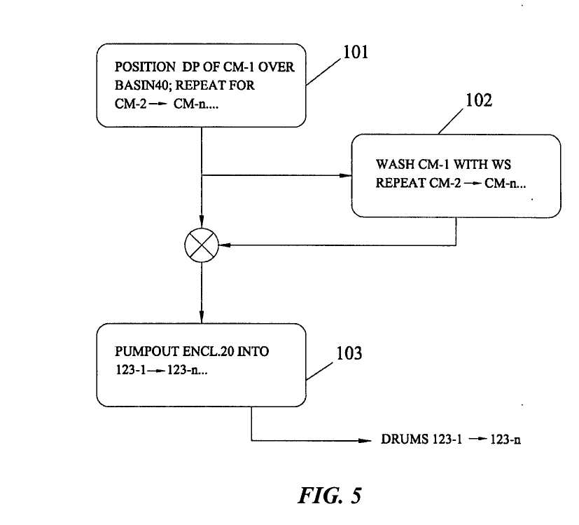

By particular reference to FIG. 5 tile foregoing inventive structure renders a sequence or process possible wherein in step 101 the dispensing parts DP of a sequence of concrete machinery CM-1 through CM-n are brought seriatim to the rear panel assembly 41 and extended over the basin 40 through the fully opened gate 42 selected to clear the lowest dispensing part above ground. Once in position, in step 102, the interior surfaces of the machinery are washed by a pressurized water stream WS with the wash product flow falling into the basin where the cement paste is separated by decanting and/or filtering and collected in enclosure 20. From there, in step 103, it is pumped into storage drums 123-1 through 123-n with steps 101, 102 and 103 occurring both contemporaneously and/or in sequence.

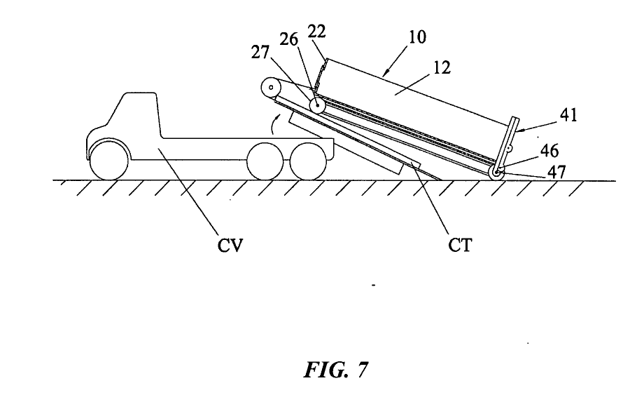

As illustrated in FIG. 7 structure 10 with the decanted debris collected in the basin 40 are then lifted onto a carrier vehicle CV that transports it for disposal. In the course of this lifting the outer rollers 46 and 47, together with the rear edges of the skid channel 14 and 15, form a fulcrum line on the ground while the forward end is lifted to place rollers 26 and 27 on corresponding tracks CT in the carrier vehicle. Of course, this pivotal motion results in a realignment of the weight vector relative the basin structure towards the more spread out rear end of plate 11 which, because of its lower sectional area moment of inertia, will result in wall and panel flexures that assist in the further fracturing of the debris collected thereon. It will be appreciated that gate panels 42 and 43 need to be fully closed during such lifting to limit any spillage, each panel further including a peripheral seal 42s and 43sto prevent leakage while stationary or during transport. Once transported to the disposal site the further weight vector movement and panel flexures assist in additional fracturing of the debris pad for convenience in the disposal thereof and the recovery of the membrane 60 if such is used.

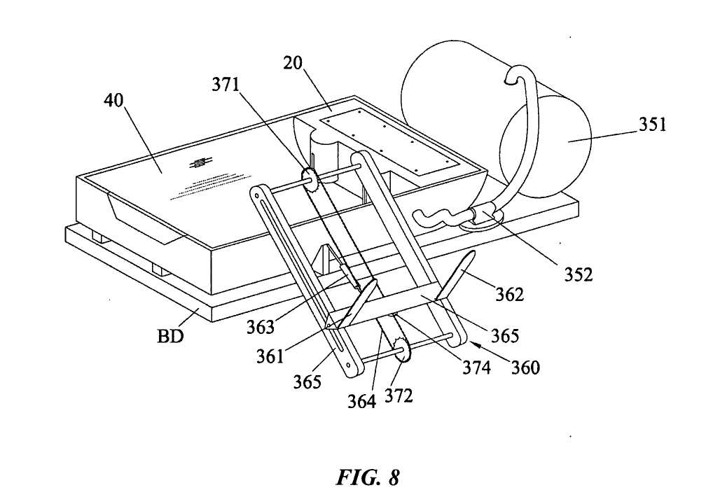

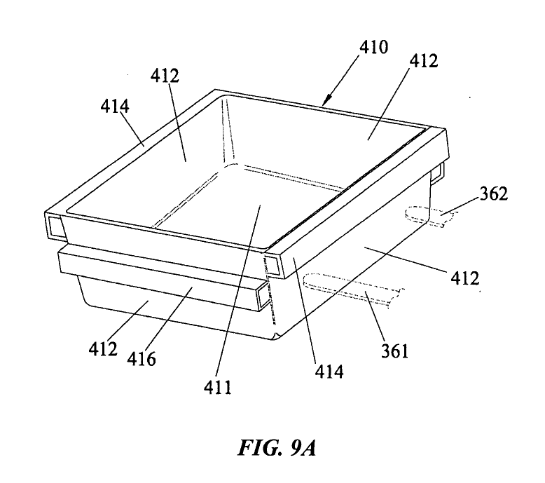

As illustrated in FIGS. 8, 9a and 9b, further use efficiency and utility of the above described wash residue movement process can be realized by mounting on the bed BD of the carrier vehicle CV on which the inventive structure 10 is placed a liquid storage tank 351 into which the caustic liquid continuously decanted into the collection enclosure 20 is pumped by a bed mounted pump 352. A forklift assembly 360 pivotally attached to one lateral edge of the bed BD adjacent the wash residue carrying basin 40 is then useful to insert a set of fork blades 361 and 362 into selected receipt pockets formed on the exterior of one of several smaller volume wash residue collection trays generally designated by the numeral 410 is then useful in raising the tray over the basin and then turning the tray to drain its contents. Preferably, assembly 360 includes a generally rectangular frame 365 pivoted about the edge of the bed BD by an actuator 363 tied to a selected link of a chain loop 364 that extends between an upper and a lower sprocket 371 and 372 mounted in the frame. A generally rectangular fork carrier 373 confined for sliding translation along the frame is connected at its upper and lower edge to a spaced set of other links in the chain loop 364 by pivotal arms 374 an 375 and hen the corresponding links in the chain are carried onto the upper sprocket 371 a tipping motion is imparted to it raising the fork blades 361 and 362 that extend from the carrier. The tray 410 supported by the fork blades is thus turned to drain its contents into basin 40.

Preferably the link engagement of actuator 363 is on a portion of the chain loop 364 that is generally opposite relative the chain engagement to the fork carrier 373 with the actuator dimensions selected such that the hydraulic contraction thereof will bring the carrier onto the lower sprocket 372 while concurrently pivoting frame 365 towards a vertical alignment. As the actuator is then hydraulically extended the fork carrier 373 is moved off the sprocket to lift the fork blades while the lower end of frame 365 is pivoted away from the edge of the bed, effecting an insertion movement of the blades into the selected pockets in tray 410. Further hydraulic extension of the actuator then produces additional pivotal displacement of the frame bringing the tray 410 over the basin 40 as the carrier 363 is turned over the upper sprocket 371 to spill any wash residue in the tray into the basin. In this manner the progression of the structure 10 through a worksite allows for the evacuation of the smaller wash residue containers that may be associated with finishing or other operations. Of course, this same collection structure, on a continuous basis, decants the problematic components of the concrete process, the highly caustic hydroxides that are entailed in the hydration processes of concrete, and then collects these for neutralization and other processing in storage tank 351.

Each of the trays 410 is defined by a generally square bottom pan 411 bounded at the periphery by a set of inclined walls 412 to form an opening of a planform that is somewhat larger than that of the bottom pan. The exterior free edge of two opposed walls 412 is then provided with an elongate pocket 414 spaced and conformed in section to receive the respective ones of the fork blades 361 and 362. The other two opposed walls 412 are similarly provided with exterior elongate pockets 416 offset vertically from pockets 414 to extend transversely on the exterior surfaces of the walls in a spaced alignment below the free edges thereof. As with the other pockets 414 pockets 416 are both spaced and conformed in receiving dimension to accommodate the fork blades. In this manner two fork receiving elevations are provided to accommodate variations in the local terrain in a structure that can be conveniently stacked in a nested stacking of trays 410-1 through 410-n when not in use. Moreover, the offset in the perimeter beam structure of each tray will promote various flexure modes as the tray is lifted on the received fork blades assisting any bond release spray or coating.

While the foregoing collection system is described in conjunction with a lateral forklift mechanism attached to the carrier bed, it will be appreciated that other, commercially available forklifts (not illustrated), such as those sold by Moffett Engineering, Ltd., Louth, Ireland under model no. D45, and distributed in the United States by Cargotec, Inc., 12233 Williams Road, Perrysburg, Ohio 43551 and outfitted with a rotary fork clamp, model no. T 451 D, can be equally useful in moving and lifting the trays 410 into position over the basin 40 to drain the wash residue collected therein. In this manner the full capacity of the collection structure 10 may be utilized both in its stationary form or as a moving platform when mounted on carrier vehicle CV.

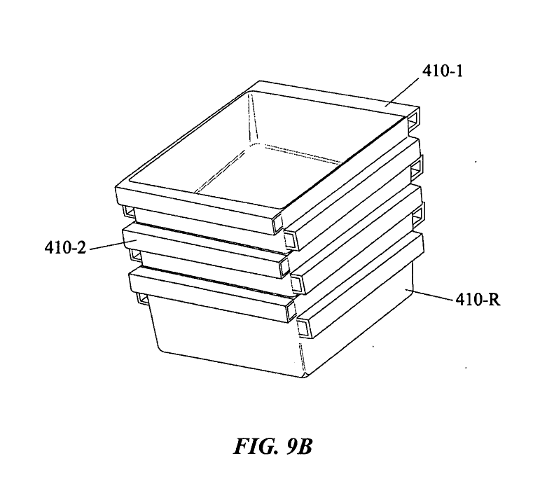

It will be appreciated that the foregoing process utilizes to its full extent the substantial wash residue collection equipment now necessary in any large building project, thereby optimizing its cost and movement efficiency. Since the safe disposal of toxic or hazardous substances is now a significant economic concern in any building project the optimization of such disposal processes has become part of the planning and management of the project. By particular reference to FIG. 10 these cost conservation effects can be enabled by a further process sequence that starts with step 111 branched off from step 102 of FIG. 5, step 111 entailing the loading of the inventive structure 10 onto the bed BD of the carrier vehicle CV and connecting cavity 20 to pump 352. At this point the solid debris content of the basin 40 is conventionally weighed or estimated in a branching step 112 to determine if there still remains a substantial amount of unused load capacity, e.g., if the solid debris loading is, for example, equal or less than 40% of maximum, and if so the carrier vehicle is directed to follow a path through the worksite in step 113 along which trays 410-1 through 410-n are positioned for dumping. As each of the trays are emptied in step 114 the solid debris collected in basin 40 is again tested in the branching step 112 and the process is continued until either all the trays 410-1 through 410-n are emptied or the maximum load is met at which time the carrier vehicle CV is directed to the dump site in step 115. To assist in the estimating process a set of scribe lines 40-u and 40-1 may be painted in the basin 40 to define the visual upper and lower limits of the solid debris maximal load. In this manner all the concrete wash processes at a work site are optimized assisting those charged with the management of the construction project in the selection of the equipment complement as well as its scheduling and its routing to the reprocessing and dump sites. In each instance convenient handling of the compromised and fractured aggregate pad, the most massive part of the wash residue, is thus further assured by the repeated agitations while the component most harmful to the environment is isolated on a continuing basis for neutralization and disposal in standardized drums, allowing for the handling and transport thereof by separately contracted enterprises that have the necessary expertise and facilities. The inert residue bulk, in turn, travels along the same paths as those used by the concrete machinery and both the job planning and the environmental aspects are comfortably conformed for these usual transport modes.

Obviously many modifications and variations of the instant invention can be effected without departing from the spirit of the teachings herein. It is therefore intended that the scope of the invention be determined solely by the claims appended hereto.

We claim:

1. Apparatus for collecting and transporting the wash residue produced in the course of cleaning concrete handling machinery, said residue including the constituent parts of concrete together with the water stream introduced in the course of washing, comprising:
an elongate containment structure defined by a forward and a rear end including a liquid impervious enclosure in the forward portion thereof for storing fluids and a rear basin open at the top and conformed to receive and contain said wash residue;
decanting means interposed between said basin and said enclosure for separating and retaining in said basin the solid portions of the sand and aggregate included in said constituents of concrete and for conveying the fluid remainder of said residue including the substantial portion of cement included in said concrete mixed with said water stream into said enclosure; and
a carrier vehicle adapted to transport said containment structure including a storage container conformed to receive said fluid remainder pumped from said enclosure.

2. Apparatus according to claim 1, further comprising.
pumping means selectively mounted on said vehicle and connected to said enclosure for pumping said fluid remainder therefrom into said storage container.

3. Apparatus according to claim 1, wherein:
said decanting means includes a housing having a first wall extending into said basin and a second wall extending into said enclosure to form a cavity therebetween, said first wall including a generally vertical slot communicating between said basin and said cavity and said second wall including an opening communicating between said cavity and said enclosure.

4. Apparatus according to claim 3, further comprising:
a filter assembly conformed for mating receipt within said cavity.

5. Apparatus according to claim 4, further comprising.
pumping means selectively mounted on said vehicle and connected to said enclosure for pumping said fluid remainder therefrom into said storage container.

6. Apparatus according to claim 5, further comprising;
a plurality of trays distributed along the path of movement of said carrier vehicle each containing concrete wash residue; and
lifting means conformed to engage selected ones of said trays for lifting thereof over said basin to drain said wash residue therein.

7. Apparatus according to claim 6, wherein:
said lifting means includes a pair of fork blades and each said tray includes at least one set of elongate pockets conformed the respective ones of the fork blades.

8. A tray useful in containing the wash residue produced in the course of washing concrete handling tools, comprising:
a generally square bottom pan;
a peripheral wall joined to the edges of said pan extending upwardly along an incline generally therefrom to form an generally square opening having dimensions larger than the planform of said bottom pan;
a first pair of elongate pockets formed on the opposite exterior first peripheral segments of said wall; and
a second pair of elongate pockets formed to extend generally orthogonally to said first pair of pockets along the exterior of the opposed second peripheral segments of said wall aligned along an offset plane relative the plane of said first pair of elongate pockets.

9. Apparatus according to claim 8, wherein:
each said first and second pair of elongate pockets is conformed to receive the blades of a forklift.

10. A method for containing the wash residue generated in the course of washing of concrete handling equipment and tools by directing a stream of washing water thereon, comprising the steps or:
positioning the concrete dispensing portion of said concrete handling equipment over a basin for capturing the wash residue comprising the constituents of concrete mixed with said stream of washing water;
decanting the liquid portion of said wash residue having the cement constituents suspended therein into an impervious enclosure while excluding therefrom the substantial portions of the sand and aggregate constituents of concrete;
mounting the basin on a carrier vehicle for movement along a path;
sequentially lifting and draining into said basin other quantities of concrete wash residue collected in trays distributed along said path; and
pumping from the impervious enclosure into a container mounted on said vehicle the liquid portion of said wash residue

11. A method according to claim 10 wherein:
the step of decanting the liquid portion includes the further other quantities of concrete wash residue drained from said trays.

12. A method according to claim 11, wherein:
the step of decanting further includes the step of accumulating the sand and aggregate portion of the wash residue to form a decanting weir.

13. A method according to claim 12 wherein:
the step of decanting the liquid portion is effected concurrent with the movement of said carrier vehicle.

14. A method according to claim 10 wherein:
the step of pumping from the impervious enclosure is effected concurrent with the movement of said carrier vehicle.
